(19) United States
(12) Patent Application Publication
(10) Pub. No.: US 2026/0341186 A1
(43) Pub. Date: Oct. 29, 2026

(54) COMPENSATION METHOD OF STRETCHABLE MICRO LED DISPLAY

(71) Applicant: SEOUL NATIONAL UNIVERSITY R&DB FOUNDATION, Seoul (KR)

(72) Inventors: Soo Yeon LEE, Seoul (KR); Ji Min KANG, Seoul (KR)

(73) Assignee: SEOUL NATIONAL UNIVERSITY R&DB FOUNDATION, Seoul (KR)

(21) Appl. No.: 19/103,586

(22) PCT Filed: Aug. 16, 2023
(86) PCT No.: PCT/KR2023/012117

§ 371 Date: Feb. 13, 2025

(30) Foreign Application Priority Data
Aug. 16, 2022 (KR) 10-2022-0101764
Aug. 16, 2023 (KR) 10-2023-0107003

(51) Int. Cl. G09G 3/00; G09G 3/32

(52) U.S. Cl. CPC G09G 3/035; G09G 3/32; G09G 2320/0233; G09G 2320/04

(57) ABSTRACT

The present invention relates to a compensation circuit for a stretchable display device including a micro-LED, and proposes a technology for compensating luminance variations occurring during the stretching process of the stretchable display device by increasing the light-emission time of the micro-LED light-emitting element.

### TECHNICAL FIELD

The present disclosure relates to a display device, and more specifically, to a micro LED light-emitting element mounted on a stretchable display device and a driving circuit included therein.

### BACKGROUND OF THE INVENTION

Recently, there has been increasing interest in stretchable display devices equipped with stretchable display panels that possess elasticity and flexibility, allowing their size (i.e., area) to be variable.

However, in stretchable display devices, when the size of the display panel changes based on its elasticity and flexibility, the area of the pixels provided in the stretchable display panel also changes, leading to a decrease in display brightness.

In addition, characteristic variations (e.g., threshold voltage shifts, mobility changes, etc.) may occur in the thin-film transistors (TFTs) within the pixels. As a result, in stretchable display devices, changes in the current flowing through the pixels can occur when the size of the stretchable display panel changes, causing luminance non-uniformity in the stretchable display panel.

Therefore, there is a need for a circuit configuration that can compensate for the reduction in luminance when the display area expands beyond its original size in display substrates made of flexible or stretchable materials.

In other words, in the case of stretchable displays, as the area increases, the luminance decreases, and a circuit configuration capable of compensating for this to maintain uniform luminance is required. However, to date, a circuit capable of solving this issue with a simple and commercially viable structure has not yet been derived.

A general micro-LED refers to an ultra-small LED with a size of 100 μm or less, and it has the advantage of enabling low power consumption, miniaturization, and lightweight design of displays due to its small size and low power consumption. In addition, unlike organic light-emitting diodes (OLEDs), which exhibit weaknesses in luminous efficiency and lifespan, micro-LEDs have excellent efficiency and lifespan and can operate under extreme conditions, such as below −20 °C and above 100 °C. Due to this potential as next-generation display technology, many domestic and international companies are currently strengthening their investments in micro-LED technology.

The micro-LED driving circuit is a circuit for implementing pixels and gray scales used for image display through scan signals and data voltages in a matrix arrangement of micro-LEDs, and generally, one pixel driving circuit is used to drive a single pixel.

However, conventional OLED-based driving circuits have used the Pulse Amplitude Modulation (PAM) driving method to represent grayscale, where the grayscale is expressed based on the amount of current flowing through the OLED. When using the PAM method, grayscale is represented by adjusting the current value, and the amount of current flowing through the OLED is controlled by the driving transistor (Driving TFT) of the driving circuit.

However, since micro-LEDs have a characteristic in which the wavelength varies depending on the amount of current, when expressing gray levels using the PAM driving method, a wavelength shift occurs, causing color changes during the pixel driving process, resulting in screen distortion, thereby making it difficult to apply the PAM driving method.

In particular, in the case of implementing a large display by connecting multiple modular-type micro-LED display panels, differences in color wavelength occur between each module, further exacerbating the issues related to grayscale representation. Therefore, there is a need to develop a driving method for self-emissive display panels that can improve color reproduction. In this context, factors such as power consumption, luminance uniformity, and horizontal crosstalk issues also need to be considered.

### DESCRIPTION OF THE INVENTION

### Problem to be Solved

The present invention is intended to solve the problems of the prior art described above, and the purpose of this disclosure is to address the issue of color changes that occur due to the stretching behavior of the display device when a micro-LED light-emitting element is mounted on a stretchable display device.

Furthermore, the present invention is intended to provide a display device equipped with a micro-LED light-emitting element having improved color reproduction.

Another object of the present disclosure is to provide a micro-LED display device capable of implementing grayscale representation by controlling the emission time while fixing the amount of current, unlike the PAM driving method, which represents grayscale based on the amount of current.

Another object of the present disclosure is to provide a micro-LED display device and a driving method thereof that offer improved color reproduction for input image signals.

Yet another object of the present disclosure is to propose a principle for a stretchable display device capable of driving inorganic light-emitting elements at the micro-LED scale more efficiently and reliably, and to provide a display device and a driving method thereof based on this principle.

A further object of the present disclosure is to provide a display device and a driving method thereof, which include a driving circuit suitable for high-density integration by optimizing the design of various circuits for driving inorganic light-emitting elements.

The technical objectives to be achieved by the present invention are not limited to the matters mentioned above, and other technical problems not mentioned can be considered by those skilled in the art based on the embodiments of the present invention described below.

### Means for Solving the Problem

The brightness (L) of a display is generally inversely proportional to the display area (A) and directly proportional to the current (I_OLED) of the light-emitting diode, and in the case of the stretchable display device currently under discussion, the problem was that when the display is stretched due to external strain (ε) , the display area increases (A(1+ε)), inevitably causing a decrease in brightness to L/(1+ε).

In such cases, for a stretchable display equipped with an OLED, it was possible to compensate for the decrease in brightness of the stretchable display by maintaining the display brightness at the same level as before stretching through increasing the OLED current (I__{OLED}) by a factor of (1+ε).

However, in the case of mounting a micro-LED light-emitting element on a stretchable display, changing the current intensity in the same manner as used in conventional stretchable displays was not a feasible approach due to the characteristics of micro-LEDs, because micro-LEDs have the issue of color changes depending on the current level.

Therefore, the inventors of the present invention propose a method to compensate for luminance degradation caused by the stretching of a display panel or the like by increasing the emission time according to the strain rate while maintaining the current level.

A compensation method for a stretchable display device including a micro-LED light-emitting element according to an embodiment of the present invention is to use a method of compensating for luminance changes occurring during the stretching process of the stretchable display device by increasing the emission time of the micro-LED light-emitting element in the compensation circuit of the stretchable display device.

According to an embodiment, the emission time of the micro-LED light-emitting element may increase in proportion to the stretching ratio of the stretchable display device.

According to an embodiment, the current level of the micro-LED light-emitting element may be maintained at the same level during the stretching process of the stretchable display device.

According to one embodiment, the control of the light emission time may be performed through a compensation circuit including a PWM circuit for adjusting the light emission time of the micro LED; and a CCG circuit for controlling a constant current to flow during light emission of the micro LED. According to one embodiment, the stretchable display device may include: a plurality of distinct regions and a sensor for detecting a stretch ratio for each of the distinct regions, and may increase the light emission time of one or more pixels including a micro LED located in the distinct region according to the detected stretch ratio of the distinct region.

A stretchable display device including a micro-LED light-emitting element, comprising:
a pixel array in which pixels composed of a plurality of inorganic light-emitting elements are arranged on a plurality of row lines;
a stretchable display panel including sub-pixel circuits provided for each of the plurality of inorganic light-emitting elements to supply a driving current to the inorganic light-emitting elements; and
a driving unit configured to set image data voltages to the sub-pixel circuits of the display panel in a row-line sequence during a data setting period, and to drive the sub-pixel circuits so that the driving current is supplied to the inorganic light-emitting elements of the pixel array in a row-line sequence based on a sweep signal that sweeps from a first voltage to a second voltage and the set image data voltages during a light-emission period;
   wherein the sub-pixel circuit includes:
a PWM circuit unit for adjusting the emission time of the micro-LED; and
a CCG circuit unit for controlling a constant current to flow during the emission of the micro-LED,
   and wherein the PWM circuit unit controls the emission time of the micro-LED in accordance with the stretching ratio of the stretchable display panel.

According to an embodiment, the stretchable display may include divided regions, each of which further includes a sensor for measuring the stretching ratio of the stretchable display, and the PWM circuit unit may be configured to control the emission time of one or more pixels, including the micro-LEDs located in the divided regions, to be increased in proportion to the measurement values of the sensors.

### Effects of the Invention

When driving micro-LEDs mounted on a stretchable display device using the method proposed in the present invention, it is possible not only to effectively control the emission time of the micro-LEDs for each region but also to achieve a uniform luminance micro-LED light-emitting effect despite the stretching operation of the stretchable display device.

### BRIEF DESCRIPTION OF THE DRAWINGS

FIG. 1 is a conceptual diagram illustrating the principle by which the luminance of a panel including light-emitting elements changes (decreases) due to stretching deformation in a stretchable display device, and how the luminance is compensated through a compensation circuit to maintain the same luminance as before the occurrence of stretching deformation.

FIG. 2 is a diagram explaining the principle of compensating for luminance degradation by increasing the emission time while maintaining the current level in a stretchable display device including a micro-LED light-emitting element according to an embodiment of the present invention.

FIG. 3 is a schematic diagram of a driving circuit for a stretchable display device including a micro-LED light-emitting element according to an embodiment of the present invention.

FIG. 4 is a schematic diagram illustrating an example of the pixel structure of a stretchable display device including a micro-LED light-emitting element according to an embodiment of the present invention.

FIG. 5 is a block diagram illustrating the configuration of a stretchable display device including a micro-LED light-emitting element according to an embodiment of the present invention.

### DETAILED DESCRIPTION OF THE INVENTION

Hereinafter, embodiments of the present invention will be described in detail with reference to the accompanying drawings. In adding reference numerals to the components of each drawing, it should be noted that the same reference numerals are used for the same components, even if they are shown in different drawings, as much as possible. In addition, in describing the embodiments of the present invention, detailed descriptions of well-known configurations or functions may be omitted if it is determined that such descriptions would hinder the understanding of the embodiments of the present invention.

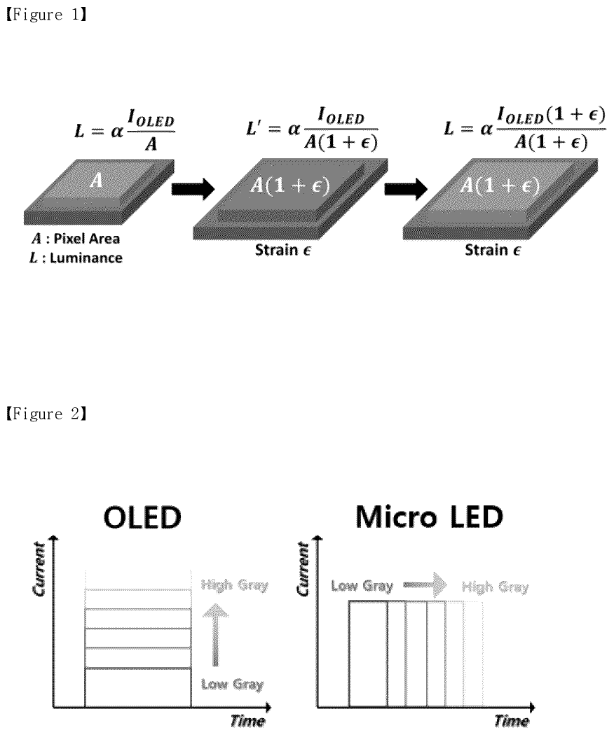

Hereinafter, a stretchable display device including a micro-LED light-emitting element and a compensation method proposed in an embodiment of the present invention will be described in detail with reference to FIGS. 1 to 5.

FIG. 1 is a conceptual diagram illustrating the principle by which the luminance of a panel including light-emitting elements changes (decreases) due to stretching deformation in a stretchable display device, and how the luminance is compensated through a compensation circuit to maintain the same luminance as before the occurrence of stretching deformation.

However, in the case of the stretchable display device shown in FIG. 1, this method is generally applicable to stretchable display devices equipped with OLEDs, and as previously described, it is difficult to apply this method to stretchable display devices equipped with micro-LEDs, where the color changes depending on the current intensity.

FIG. 2 is a diagram illustrating the principle of compensating for luminance degradation by increasing the emission time while maintaining the current level in a stretchable display device including a micro-LED light-emitting element according to an embodiment of the present invention.

The inventors of the present invention recognized the difficulty of applying the method considered in FIG. 1 to micro-LEDs and considered a method of compensating for luminance by adjusting the emission time while maintaining the current at an equal level, as shown in FIG. 2.

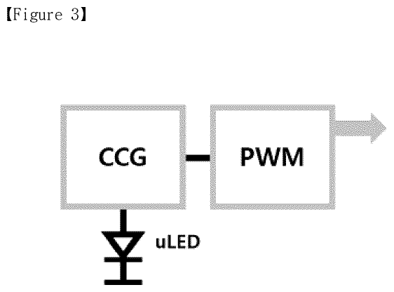

FIG. 3 is a schematic diagram of a driving circuit for a stretchable display device including a micro-LED light-emitting element according to an embodiment of the present invention.

This schematic diagram illustrates the configuration of a compensation circuit for the micro-LED, which includes a PWM circuit unit and a CCG circuit unit.

The compensation circuit of the stretchable display device proposed in the present invention may, in one example, be configured as a combination of a PWM (Pulse Width Modulation) circuit unit and a CCG (Constant Current Generation) circuit unit. In this case, specifically, the PWM circuit unit may perform the role of adjusting the emission time of the micro-LED, and the CCG circuit unit may perform the role of ensuring that a constant current flows during the emission of the micro-LED.

In one embodiment, the PWM circuit unit may be configured to include a PWM driving transistor, and the PWM circuit unit may determine the on/off timing of the PWM driving transistor through a comparison between the data voltage (Vdata) and the sweep voltage (Vsweep). In addition, the PWM circuit unit may also perform the role of compensating for the threshold voltage of the PWM circuit unit driving TFT.

In one embodiment, the CCG circuit unit may also perform the role of compensating for the threshold voltage of the CCG circuit unit driving TFT.

A compensation method for a stretchable display device including a micro-LED light-emitting element according to an embodiment of the present invention is to use a method of compensating for luminance changes occurring during the stretching process of the stretchable display device by increasing the emission time of the micro-LED light-emitting element in the compensation circuit of the stretchable display device.

If the current applied to the micro-LED is kept constant and only the emission time is increased according to the degree of stretching, it may be possible to achieve uniform luminance despite the stretching behavior of the display device.

According to an embodiment, the emission time of the micro-LED light-emitting element may increase in proportion to the stretching ratio of the stretchable display device.

According to an embodiment, the current level of the micro-LED light-emitting element may be maintained at the same level during the stretching process of the stretchable display device.

According to an embodiment, the control of the emission time may be performed through a compensation circuit comprising a PWM circuit unit for adjusting the emission time of the micro-LED; and a CCG circuit unit for controlling a constant current to flow during the emission of the micro-LED.

According to an embodiment, the stretchable display device may include a plurality of divided regions and sensors for detecting the stretching ratio for each of the divided regions, and the emission time of one or more pixels, including micro-LEDs located in the divided regions, may be increased according to the detected stretching ratio of the divided regions.

As described above, in a stretchable display device equipped with micro-LEDs, the degree of stretching may vary by region. According to an embodiment, uniform luminance may be maintained by identifying the degree of stretching that differs by region and controlling the emission time of the pixels in regions with a higher degree of stretching accordingly.

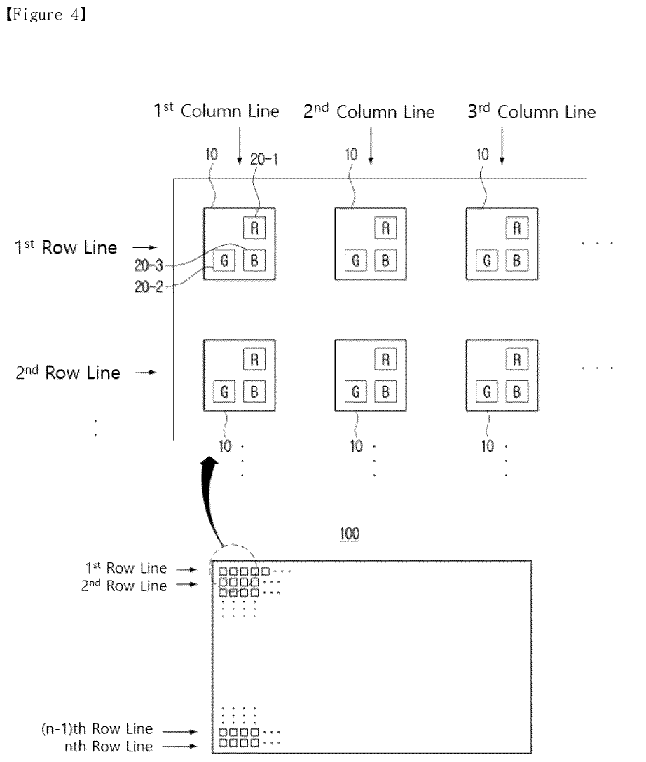

FIG. 4 is a schematic diagram illustrating an example of the pixel structure of a stretchable display device including a micro-LED light-emitting element according to an embodiment of the present invention.

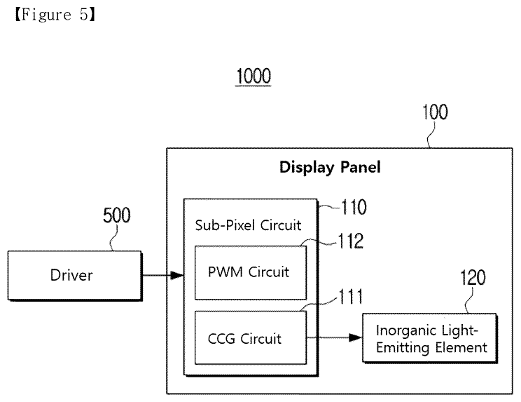

FIG. 5 is a block diagram illustrating the configuration of a stretchable display device including a micro-LED light-emitting element according to an embodiment of the present invention.

Hereinafter, a stretchable display device including a micro-LED light-emitting element and a circuit that can be mounted thereon according to an embodiment of the present invention will be described with reference to FIGS. 4 and 5.

A stretchable display device including a micro-LED light-emitting element, comprising: a pixel array in which pixels composed of a plurality of inorganic light-emitting elements are arranged on a plurality of row lines; a stretchable display panel including sub-pixel circuits provided for each of the plurality of inorganic light-emitting elements to supply a driving current to the inorganic light-emitting elements; and a driving unit configured to set image data voltages to the sub-pixel circuits of the display panel in a row-line sequence during a data setting period, and to drive the sub-pixel circuits so that the driving current is supplied to the inorganic light-emitting elements of the pixel array in a row-line sequence based on a sweep signal that sweeps from a first voltage to a second voltage and the set image data voltages during a light-emission period; wherein the sub-pixel circuit includes: a PWM circuit unit for adjusting the emission time of the micro-LED; and a CCG circuit unit for controlling a constant current to flow during the emission of the micro-LED, and wherein the PWM circuit unit controls the emission time of the micro-LED in accordance with the stretching ratio of the stretchable display panel.

According to an embodiment, the stretchable display may include divided regions, each of which further includes a sensor for measuring the stretching ratio of the stretchable display, and the PWM circuit unit may be configured to control the emission time of one or more pixels, including the micro-LEDs located in the divided regions, to be increased in proportion to the measurement values of the sensors.

The above description is merely illustrative of the technical idea of the present invention, and various modifications and changes can be made without departing from the essential characteristics of the present invention by those skilled in the art to which the present invention pertains. Therefore, the embodiments disclosed in the present invention are not intended to limit the technical idea of the present invention but to describe it, and the scope of the technical idea of the present invention is not limited by these embodiments. The scope of protection of the present invention should be interpreted based on the following claims, and all technical ideas within the equivalent scope should be construed as being included within the scope of rights of the present invention.

1. A compensation method for a stretchable display device including a micro-LED light-emitting element,
wherein the method compensates for luminance variations occurring during the stretching process of the stretchable display device
by increasing the light-emission time of the micro-LED light-emitting element.

2. The compensation method for a stretchable display device including a micro-LED light-emitting element according to claim 1,
wherein the light-emission time of the micro-LED light-emitting element increases in proportion to the stretching ratio of the stretchable display device.

3. The compensation method for a stretchable display device including a micro-LED light-emitting element according to claim 1,
wherein the current level of the micro-LED light-emitting element is maintained constant during the stretching process of the stretchable display device.

4. The compensation method for a stretchable display device including a micro-LED light-emitting element according to claim 1,
wherein the control of the light-emission time is performed through a compensation circuit comprising: a PWM circuit unit configured to adjust the light-emission time of the micro-LED; and a CCG circuit unit configured to control a constant current flow during the light emission of the micro-LED.

5. The compensation method for a stretchable display device including a micro-LED light-emitting element according to claim 4,
wherein the stretchable display device includes a plurality of divided regions and sensors for detecting the stretching ratio of each divided region,
and wherein the light-emission time of one or more pixels, including micro-LED light-emitting elements located in the corresponding divided region, is increased based on the detected stretching ratio of the divided region.

6. A stretchable display device including a driving circuit for micro-LEDs, comprising: a pixel array in which pixels composed of a plurality of inorganic light-emitting elements are arranged along multiple row lines;
a stretchable display panel including sub-pixel circuits provided for each of the plurality of inorganic light-emitting elements to supply a driving current to the inorganic light-emitting elements; and
a driving unit configured to set image data voltages to the sub-pixel circuits of the display panel in a row line sequence during a data setting period, and to drive the sub-pixel circuits such that the driving current is supplied to the inorganic light-emitting elements of the pixel array in a row line sequence during a light-emission period, based on a sweep signal that sweeps from a first voltage to a second voltage and the set image data voltages;
wherein each of the sub-pixel circuits includes: a PWM circuit unit configured to adjust the light-emission time of the micro-LED; and
a CCG circuit unit configured to control a constant current flow during the light emission of the micro-LED;
and wherein the PWM circuit unit controls the light-emission time of the micro-LED in response to the stretching ratio of the stretchable display panel.

7. The stretchable display device including a micro-LED light-emitting element according to claim 6,
wherein the stretchable display includes divided regions,
each of the divided regions further comprising a sensor for measuring the stretching ratio of the stretchable display,
and wherein the PWM circuit unit controls the light-emission time of one or more pixels, including micro-LED light-emitting elements located in the corresponding divided region, to increase in proportion to the measurement values obtained from the sensor.
